(19) United States
(12) Patent Application Publication
(10) Pub. No.: US 2024/0036240 A1
(43) Pub. Date: Feb. 1, 2024

(54) OPTICAL ANGULAR FILTER

(71) Applicant: ISORG, Limoges CEDEX 3 (FR)

(72) Inventors: Benjamin BOUTHINON, GRENOBLE (FR); Delphine DESCLOUX, GRENOBLE (FR); Wilfrid SCHWARTZ, GRENOBLE (FR)

(21) Appl. No.: 18/266,529

(22) PCT Filed: Nov. 22, 2021
(86) PCT No.: PCT/EP2021/082403

§ 371 Date: Jun. 9, 2023

(30) Foreign Application Priority Data
Dec. 14, 2020 (FR) 2013150

(51) Int. Cl. G02B 5/20; G02B 3/00

(52) U.S. Cl. CPC G02B 5/201; G02B 3/0006; G02B 2207/123

(57) ABSTRACT

An angular filter for an image acquisition device including a stack, includes: a first array of first openings delimited by first walls opaque to a visible and/or infrared radiation; an array of microlenses; and a second array of second openings delimited by second walls opaque to the visible and/or infrared radiation.

### RELATED APPLICATION

The present application is based on and claims priority of French patent application FR2013150 filed on Dec. 14, 2020 and entitled “Filtre angulaire optique”, which is incorporated herein by reference as authorized by law.

### FIELD

The present disclosure concerns an optical angular filter.

More particularly, the present disclosure concerns an optical angular filter intended to be used within an optical system, for example, an imaging system or to be used to collimate the rays of a light source, particularly for an application of directional illumination with an organic light-emitting diode (OLED) or of optical inspection.

### BACKGROUND

An angular filter or filter is a device enabling to filter an incident radiation according to the incidence of this radiation and thus to block rays having an incidence greater than a maximum incidence. Angular filters are frequently used in association with image sensors.

### SUMMARY OF THE INVENTION

There is a need to improve known angular filters.

An embodiment overcomes all or part of the disadvantages of known angular filters.

An embodiment provides an angular filter for an image acquisition device comprising a stack comprising:
a first array of first openings delimited by first walls opaque to a visible and/or infrared radiation;
an array of microlenses; and
a second array of second openings delimited by second walls opaque to the visible and/or infrared radiation.

According to an embodiment, the number of second openings is, at least, twice greater than the number of first openings.

According to an embodiment, the number of first openings is, at least, twice greater than the number of second openings.

According to an embodiment, the array of microlenses is located between the first array and the second array.

According to an embodiment, the second array is located between the array of microlenses and the first array.

According to an embodiment, the first array is located between the array of microlenses and the second array.

According to an embodiment:
the structure comprising the array of microlenses and the first array is adapted to blocking incident rays having an incidence, relative to the optical axes of the microlenses, greater than a first maximum incidence; and the second array is adapted to blocking incident rays having an incidence, relative to the optical axes of the microlenses, greater than a second maximum incidence, the second maximum incidence being greater than the first maximum incidence.

According to an embodiment, the first maximum incidence which corresponds to the half width at half maximum of the transmittance is smaller than 10°, preferably smaller than 4°.

According to an embodiment, the second maximum incidence which corresponds to the half width at half maximum of the transmittance is greater than 15° and smaller than 60°.

According to an embodiment, the second maximum incidence is smaller than or equal to 30°.

According to an embodiment, the first openings are filled with air, with a partial vacuum, or with a material at least partially transparent in the visible and infrared ranges.

According to an embodiment, the second openings are filled with air, with a partial vacuum, or with a material at least partially transparent in the visible and infrared ranges.

According to an embodiment, a single microlens is vertically in line with a first opening.

According to an embodiment, each microlens is vertically in line with a single first opening.

According to an embodiment, the optical axis of each microlens is aligned with the center of a first opening.

An embodiment provides an image acquisition deice comprising an angular filter such as described hereabove and an image sensor.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 illustrates, in a partial and simplified cross-section view, an embodiment of an image acquisition system;

FIG. 2 illustrates, in a partial and simplified cross-section view, an embodiment of an image acquisition system comprising an angular filter;

Figure illustrates, in a partial and simplified cross-section view, another embodiment of an image acquisition system;

FIG. 4 illustrates, in a partial and simplified cross-section view, another embodiment of an image acquisition system; and

FIG. 5 shows, in a graph, the transmittance of the angular filter of the device illustrated in FIG. 2 according to the incidence of the rays reaching the angular filter.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the forming of the image sensor and of the elements other than the angular sensor has not been detailed, the described embodiments and implementation modes being compatible with usual embodiments of the sensor and of these other elements.

In the following disclosure, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made, unless specified otherwise, to the orientation of the figures.

Unless specified otherwise, the expressions “around”, “approximately”, “substantially” and “in the order of” signify within 10%, and preferably within 5%.

Unless specified otherwise, the expressions “all the elements”, “each element”, signify between 95% and 100% of the elements.

Unless specified otherwise, the expression “it only comprises the elements” signifies that it comprises, by at least 90%, the elements, preferably that it comprises, by at least 95%, the elements.

In the following description, unless specified otherwise, a layer or a film is called opaque to a radiation when the transmittance of the radiation through the layer or the film is smaller than 10%. In the following description, a layer or a film is called transparent to a radiation when the transmittance of the radiation through the layer or the film is greater than 10%. According to an embodiment, for a same optical system, all the elements of the optical system which are opaque to a radiation have a transmittance which is smaller than half, preferably smaller than one fifth, more preferably smaller than one tenth, of the lowest transmittance of the elements of the optical system transparent to said radiation. In the rest of the disclosure, there is called “useful radiation” the electromagnetic radiation crossing the optical system in operation. In the following description, “micrometer-range optical element” designates an optical element formed on a surface of a support having a maximum dimension, measured parallel to said surface, greater than 1 μm and smaller than 1 mm.

Embodiments of optical systems will now be described for optical systems comprising an array of micrometer-range optical elements in the case where each micrometer-range optical element corresponds to a micrometer-range lens, or microlens, formed of two dioptres. It should however be clear that these embodiments may also be implemented with other types of micrometer-range optical elements, where each micrometer-range optical element may for example correspond to a micrometer-range Fresnel lens, to a micrometer-range index gradient lens, or to a micrometer-range diffraction grating.

In the following description, visible light designates an electromagnetic radiation having a wavelength in the range from 400 nm to 700 nm and, in this range, red light designates an electromagnetic radiation having a wavelength in the range from 600 nm to 700 nm. Call infrared radiation an electromagnetic radiation having a wavelength in the range from 700 nm to 1 mm. In infrared radiation, one can in particular distinguish near infrared radiation having a wavelength in the range from 700 nm to 1.7 μm.

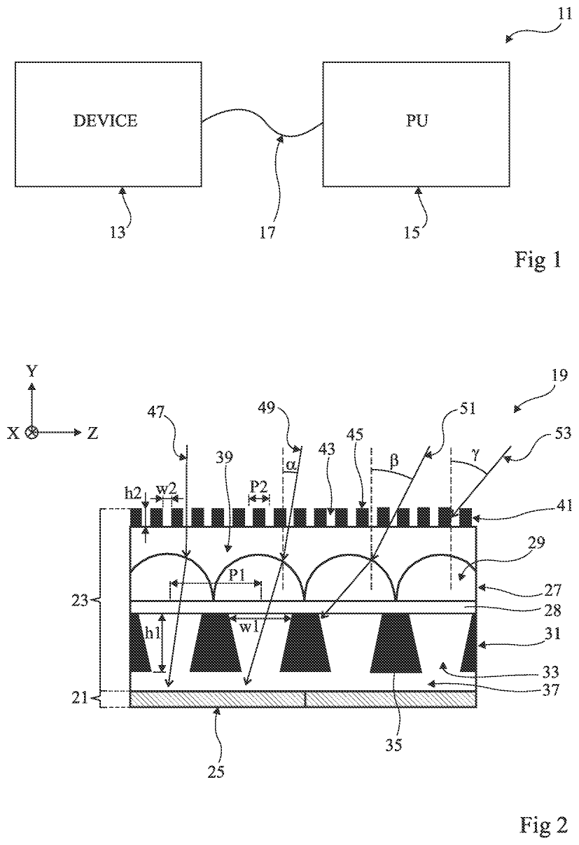

FIG. 1 illustrates, by a partial and simplified cross-section view, an embodiment of an image acquisition system 11.

Image acquisition system 11, illustrated in FIG. 1, comprises:
an image acquisition device 13 (DEVICE); and
a processing unit 15 (Processing Unit—PU).

Processing unit 15 preferably comprises means for processing the signals delivered by device 11, not shown in FIG. 1. Processing unit 15 for example comprises a microprocessor.

Device 13 and processing unit 15 are preferably coupled by a link 17. Device 13 and processing unit 15 are for example integrated in a same circuit.

FIG. 2 illustrates, in a partial and simplified cross-section view, an embodiment of an image acquisition device 19 comprising an angular filter.

The image acquisition device 19 shown in Figure comprises, from bottom to top in the orientation of the drawing:
an image sensor 21; and
an angular filter 23, covering image sensor 21.

In the present description, the embodiments of the devices of FIGS. 2 to 4 are shown in space according to a direct orthogonal XYZ coordinate system, the Y axis of the XYZ coordinate system being orthogonal to the upper surface of image sensor 21.

Image sensor 21 comprises an array of photon sensors 25, also called photodetectors. Photodetectors 25 are preferably arranged in array form. Photodetectors 25 may be covered with a protection coating and/or with a color filter (not shown). Photodetectors 25 preferably all have the same structure and the same properties/features. In other words, all photodetectors 25 are substantially identical, to within manufacturing differences. Image sensor 21 further comprises conductive tracks and switching elements, particularly transistors, not shown, allowing the selection of photodetectors 25. Photodetectors 25 are preferably made of organic materials. Photodetectors 25 may correspond to organic photodiodes (OPD), to organic photoresistors, to amorphous or single-crystal silicon photodiodes integrated on a substrate with thin film transistors (TFT) or a substrate with metal oxide gate field-effect transistors, also called MOS (Metal Oxide Semiconductor) transistors.

The organic photodiodes 25 of image sensor 21 for example comprise a mixture of poly(3,4-ethylenedioxythiophene) (PEDOT) and of sodium poly(styrene sulfonate) (PSS). The substrate is for example made of silicon, preferably, of single-crystal silicon. The channel, source, and drain regions of the TFT transistors are for example made of amorphous silicon (a-Si), of indium gallium zinc oxide (IGZO), or of low temperature polysilicon (LTPS).

According to an embodiment, each photodetector 25 is adapted to detecting the visible radiation and/or the infrared radiation.

Angular filter 23 comprises:
an array 27 of micrometer-range microlenses 29, for example, plano-convex;
a first array 31 or layer of first holes or openings 33 delimited by first walls 35 opaque in the visible and/or infrared range; and
a second array 41 of second holes 43 or openings delimited by second walls 45, the array 27 of microlenses 29 being located between first array 31 and second array 41.

According to an embodiment, the array 27 of microlenses 29 is formed on top of and in contact with a substrate or support 28, substrate 28 then being interposed between microlenses 29 and first array 31.

Substrate 28, when it is present, may be made of a transparent polymer which does not absorb at least the considered wavelengths, here in the visible and infrared range. The polymer may in particular be polyethylene terephthalate PET, poly(methyl methacrylate) PMMA, cyclic olefin polymer (COP), polyimide (PI), polycarbonate (PC). The thickness of substrate 28 may vary between 1 μm and 100 μm, preferably between 10 μm and 100 μm. Substrate 28 may correspond to a colored filter, to a polarizer, to a half-wave plate or to a quarter-wave plate.

Lenses 29 may be made of silica, of PMMA, of positive resist, of PET, of poly(ethylene naphthalate) (PEN), of COP, of polymethylsiloxane (PDMS)/silicone, of epoxy resin, or of acrylate resin. Microlenses 29 may be formed by creeping of resist blocks. Microlenses 29 may further be formed by imprinting on a layer of PET, PEN, COP, PDMS/silicone, of epoxy resin, or of acrylate resin. Microlenses 29 are converging microlenses, each having a focal distance f in the range from 1 μm to 100 μm, preferably from 1 μm to 70 μm. According to an embodiment, all microlenses 29 are substantially identical.

According to the present embodiment, microlenses 29 and substrate 28, when it is present, are preferably made of materials which are transparent or partially transparent, that is, transparent in a portion of the spectrum considered for the targeted field, for example, imaging, over the wavelength range corresponding to the wavelengths used during the exposure of an object to imaged.

The planar surfaces of microlenses 29 face first openings 33.

Call “h1” the thickness of first walls 35. Walls 35 are, for example, opaque to the radiation detected by photodetectors 25, for example, absorbing and/or reflective with respect to the radiation detected by photodetectors 25. Walls 35 absorb or reflect in the visible range and/or near infrared and/or infrared. Walls 35 are for example, opaque to wavelengths in the range from 450 nm to 570 nm, used for imaging (for example, biometry and fingerprint imaging) and/or opaque to red and infrared wavelengths.

In the present disclosure, there is called upper surface of layer 31 the surface of layer 31 located at the interface between layer 31 and substrate 28 (or if present, the array of microlenses 29). There is further called lower surface of layer 31 the surface of layer 31 located opposite to the upper surface.

In FIG. 2, openings 33 are shown with a trapezoidal cross-section in the YZ plane. Generally, each opening 33 may have a square, rectangular shape, or be funnel-shaped. Each opening 33, in top view (that is, in the XZ plane), may have a circular, oval, or polygonal shape, for example, triangular, square, rectangular, or trapezoidal. Each opening 33, in top view, has a preferably circular shape. There is defined by width of an opening 33 the characteristic dimension of opening 33 in the XZ plane. For example, for an opening 33 having a square-shaped cross-section in the XZ plane, the width corresponds to the dimension of a side and for an opening 33 having a circular-shaped cross-section in the XZ plane, the width corresponds to the diameter of opening 33. In the shown example, the width of openings 33, at the level of the upper surface of layer 31, is greater than the width of openings 33, at the level of the lower surface of layer 31. Further, there is called center of an opening 33 the point located at the intersection of the axis of symmetry of openings 33 and of the lower surface of layer 31. For example, for circular openings 33, the center of each opening 33 is located on the axis of revolution of opening 33.

According to an embodiment, the first openings 33 are arranged in rows and in columns. The rows, the columns, may be arranged in quincunx, that is, two successive rows, two successive columns, are out of alignment. Openings 33 may have all substantially the same dimensions. Call “w1” the diameter of openings 33 (measured at the base of the openings, that is, at the interface with substrate 28 or microlenses 29). Call “P1” the repetition pitch of openings 33, that is, the distance, along axis X or axis Z, between centers of two successive openings 33 of a row or of a column.

Each first opening 33 is preferably associated with a single microlens 29 of first array 31. The optical axes of microlenses 29 are preferably aligned with the centers of the openings 33 of first array 31. The diameter of microlenses 29 is preferably greater than the maximum cross-section (measured perpendicularly to the optical axes) of openings 33.

Pitch P1 may be in the range from 4 μm to 50 μm, for example equal to approximately 15 μm. Height h1 may be in the range from 1 μm to 1 mm, preferably, in the range from 1 μm to 20 μm. Width w1 may, preferably, be in the range from 1 μm to 50 μm, for example equal to approximately 10 μm.

According to the embodiment illustrated in FIG. 2, each photodetector 25 is associated with four openings 33 (it is for example associated with two openings 33 along the X axis and two openings 33 along the Z axis). In practice, the resolution of angular filter 23 may be more than four times greater than the resolution of image sensor 21. In other words, in practice, there may be more than four times more first openings 33 than photodetectors 25.

The structure associating the array 27 of microlenses 29 and first array 31 is adapted to filtering the incident radiation according to the incidence of the radiation with respect to the optical axes of the microlenses 29 of array 27. In other words, the structure is adapted to filtering the incident rays, arriving on the microlenses, according to their incidences. The structure associating the array 27 of microlenses 29 and first array 31 is adapted to blocking the rays of the incident radiation having their respective incidences with respect to the optical axes of the microlenses 29 of filter 23 greater than a first maximum incidence. This structure is adapted to only letting through rays having an incidence with respect to the optical axes of microlenses 29 smaller than the first maximum incidence. For example, the structure only lets through incident rays having an incidence smaller than 45°, preferably smaller than 30°, more preferably smaller than 10°, more preferably still smaller than 4°, for example, in the order of 3.5°.

First openings 33 are for example filled with air, with partial vacuum, or with a material at least partially transparent in the visible and infrared ranges. The filling material of openings 33 optionally forms a layer 37 at the lower surface of first array 31 to cover first walls 35 and planarize said lower surface of first array 31.

Microlenses 29 are preferably covered with a planarization layer 39. Layer 39 is made of a material at least partially transparent in the visible and infrared ranges, it may then play the role of a color filter.

According to the embodiment illustrated in FIG. 2, the second array is located above the array 27 of microlenses 29. More precisely, the second array is located on the upper surface of layer 39.

Call “h2” the thickness of second walls 45. The second walls 45 are for example of same nature and of same opacity as the first walls 35.

In FIG. 2, openings 43 are shown with a rectangular cross-section in the YZ plane. Generally, each opening 33 may have a square, triangular, trapezoidal shape, or be funnel-shaped. Each opening 43, in top view (XZ plane), may have a circular, oval, or polygonal shape, for example, triangular, square, rectangular, or trapezoidal. Each opening 43, in top view, has a preferably circular shape.

According to an embodiment, the second openings 43 are arranged in rows and in columns. The openings may be arranged in quincunx. Openings 43 may all have substantially the same dimensions (to within manufacturing dispersions). Call “w2” the width or the diameter of openings 43 (measured at the base of the openings, that is, at the interface with substrate 39). According to an embodiment, openings 43 are regularly arranged in rows and in columns. Call “P2” the repetition pitch of openings 43, that is, the distance in top view between centers of two successive openings 43 of a row or of a column.

According to the embodiment illustrated in FIG. 2, there are at least twice more, preferably at least four times more, second openings 43 than first openings 33. Thus, pitch P2 is smaller than pitch P1 and width w2 is smaller than width w1. An advantage of providing a pitch P2 smaller than pitch P1, and thus a number of openings 43 greater than the number of openings 41, is that this enables to have no impact on the quality of the image formed on the sensor (derived of Nyquist's theory). In particular, in the example of FIG. 2, array 41 will not be imaged on the sensor through array 31. This is particularly true when the pitch P2 of array 41 is at least twice and preferably four times smaller than the pitch P1 of array 31. An alternative solution would be to perfectly align the 2 arrays but this may be relatively complex to implement. Providing a pitch difference, preferably by a factor at least equal to 2, enables not to have to perform this alignment.

According to an embodiment, there are at least twice more, preferably at least four times more, first openings 33 than second openings 43. Thus, pitch P1 is smaller than pitch P2 and width w1 is smaller than width w2.

Pitch P2 may be in the range from 4 μm to 50 μm, for example, equal to approximately 6 μm. Height h2 may be in the range from 1 μm to 100 mm, preferably be in the range from 1 μm to 50 μm. Width w2 may preferably be in the range from 1 μm to 45 μm, for example be equal to approximately 4 μm.

Second openings 43 are for example filled with air, with partial vacuum, or with a material at least partially transparent in the visible and infrared ranges, for example, a material used as a color filter.

Second array 41 is adapted to filtering the incident radiation according to the incidence of the radiation with respect to the Y axis. Second array 41 is adapted to only letting through rays having an incidence smaller than a second maximum incidence, greater than the first maximum incidence. In other words, second array 41 is adapted to only letting through rays, arriving on array 41, having an incidence smaller than the second maximum incidence. The second incidence is preferably greter than 15°. The second maximum incidence is preferably smaller than 60°, preferably smaller than or equal to 30°. In other words, second array 41 is adapted to blocking incident rays having respective incidences, with respect to the Y axis, greater than the second maximum incidence.

The structure comprising the array 27 of microlenses 29 and the first array 31 of openings 33 theoretically enables to block all rays having an incidence greater than the first maximum incidence. However, in practice, it can be observed that certain rays having incidences greater than the first maximum incidence however succeed in crossing first array 31. These are rays having incidences greater than the first maximum incidence which reach a microlens 29 and pass through the underlying opening 33 of a neighboring microlens 29. This phenomenon is called optical crosstalk or parasitic coupling and may cause a decrease in the resolution of photodetectors 25. Second array 41 aims at blocking rays having incidences greater than the second maximum incidence and which might cause optical crosstalk.

In FIG. 2, each ray arrives with the same incidence onto the upper surface of array 41 and onto microlenses 29. In FIG. 2, when it is spoken of incident rays, it is then spoken of rays incident to image acquisition device 19. The radiation incident to device 19 comprises:
rays 47 having a null incidence (perpendicular to the planar surfaces of microlenses 29);
rays 49 having an incidence a greater than 0° and smaller than or equal to the first maximum incidence, for example, approximately 4°;
rays 51 having an incidence β greater than the first maximum incidence and smaller than or equal to the second maximum incidence, for example, approximately 20°; and rays 53 having an incidence γ greater than the second maximum incidence.

Part of the rays incident to device 19 are however blocked by the walls while they have an incidence smaller than the second maximum incidence. These are the rays which arrive onto the upper surfaces of walls 45 or onto the sides of walls 45. The proportion of rays having incidences smaller than the second maximum incidence and however blocked depends on the respective incidence of the rays. These rays having incidences smaller than the second maximum incidence and however blocked are not shown in FIG. 2.

The incident rays 47, 49, and 51 illustrated in FIG. 2 are the incident rays having an incidence smaller than the second maximum incidence and which are neither blocked by the upper surfaces nor by the sides of walls 45.

Each ray 47 crosses second array 41 and the array 27 of microlenses 29 by emerging from the microlens 29 that it crosses to pass through the image focus of said microlens 29. The image focus of each microlens 29 is located on top of or in the vicinity of the lower surface of the first array 31 of first openings 33, at the center of the opening 33 with which microlens 29 is associated. The structure associating the array 27 of microlenses 29 and first array 31 does not block rays 47. Each ray 47 is thus captured by image sensor 21 and more precisely by the underlying photodetector 25 of the microlens 29 crossed by ray 47.

Rays 49 are similar to rays 47, in their travels throughout angular filter 23. Neither second array 41, nor the structure associating the array 27 of microlenses 29 and first array 31 block rays 47. Each ray 47 is thus captured by image sensor 21 and more precisely by the underlying photodetector 25 of the microlens 29 crossed by said ray.

Each ray 51 crosses second array 41 to reach microlenses 29. Rays 51 are however blocked by the structure associating the array 27 of microlenses 29 and first array 31, conversely to rays 49 or 47. Rays 51 thus do not reach photodetectors 25.

Rays 53, having incidences greater than the second maximum incidence, are integrally blocked by second array 41. Rays 53 thus do not reach microlenses 29 and photodetectors 25.

At the output of angular filter 23, image sensor 21 then only captures rays 47 and 49, having incidences smaller than the first maximum incidence.

FIG. 3 illustrates, in a partial and simplified cross-section view, another embodiment of an image acquisition device 55.

More particularly, FIG. 3 illustrates an image acquisition device 55 similar to the device 19 illustrated in FIG. 2, with the difference that second array 41 is located between the array 27 of microlenses 29 and first array 31.

In FIG. 3, second array 41 is located between the array 27 of microlenses 29 and substrate 28 however, in practice, second array 41 may be located between substrate 28 and first array 31.

According to the embodiment illustrated in FIG. 3, and conversely to the device 19 illustrated in FIG. 2, the incident rays here first reach microlenses 29 and are deviated by them. The deviated rays are then filtered by second array 41 and then by first array 31.

As an example, each ray 47, 49, 51, and 53 refracted by a microlens 29 is deviated by an angle to form an angle δ, α′, β′, γ′ with the optical axis of microlens 29.

Those of rays 47, 49, 51, and 53 arriving on the upper surface of second array 41 with an incidence greater than the second maximum incidence are blocked by second array 41. Further, those of rays 47, 49, 51, 53 arriving on the array of microlenses 29 with an incidence greater than the first maximum incidence are blocked by first array 31.

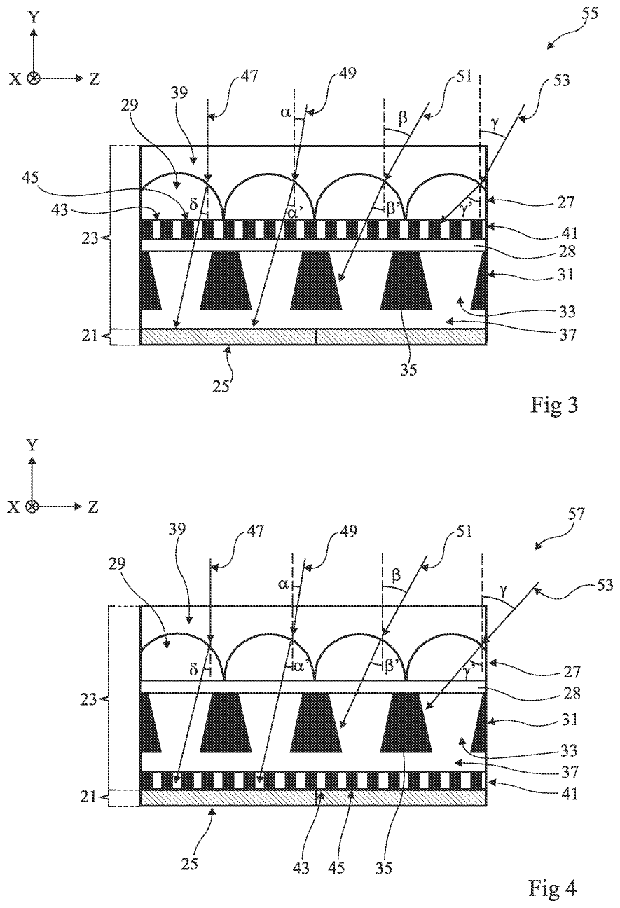

FIG. 4 illustrates, in a partial and simplified cross-section view, another embodiment of an image acquisition device 57.

More particularly, FIG. 4 illustrates an image acquisition device 57 similar to the device 55 illustrated in FIG. 3, with the difference that second array 41 is located between first array 31 and image sensor 21.

According to the embodiment illustrated in FIG. 4, and conversely to the device 19 illustrated in FIG. 2, the incident rays first reach microlenses 29 and are deviated by them. The deviated rays are then filtered, by first array 31 and then by second array 41.

Similarly to device 55, each ray 47, 49, 51 and 53 refracted by a microlens 29 is deviated by an angle to form an angle δ, α′, β′, γ′ with the optical axis of microlens 29.

Those of rays 47, 49, 51, and 53 arriving on the array 27 of microlenses 29 with an incidence greater than the first maximum incidence are blocked by first array 31. Those of rays 47, 49, 51, 53 arriving on the upper surface of the second array with an incidence greater than the second maximum incidence are blocked by second array 41.

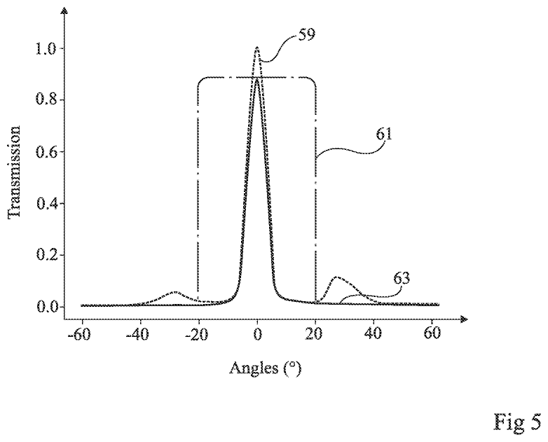

FIG. 5 shows, in a graph, the transmittance of the angular filter of the device illustrated in FIG. 2 according to the incidence of the rays reaching the angular filter.

More particularly, FIG. 5 illustrates three curves 59, 61, and 63, each representing the normalized transmittance (Transmission) of the rays in different portions of the angular filter 23 illustrated in FIG. 2, according to the incidence of said rays (Angles (°)).

The graph illustrated in FIG. 5 comprises:
a curve 59 corresponding to the transmittance of the rays crossing the structure associating the array 27 of microlenses 29 and first array 31;
a curve 61 corresponding to the transmittance of the rays crossing second array 41; and
a curve 63 corresponding to the transmittance of the rays entirely crossing the angular filter 23 such as illustrated in FIG. 2.

Each of curves 59, 61, and 63 has been obtained by a simulation where:
the focal distance of microlenses 29 is in the range from 10 μm to 70 μm;
microlenses 29 are positioned on top of and in contact with a substrate having a thickness in the range from 10 μm to 60 μm;
the first openings 33 have a trapezoidal shape;
openings 33 have a width w1 at the level of the upper surface of array 31 in the range from 1 μm to 45 μm, a width at the level of the lower surface of array 31 in the range from 1 μm to 40 μm, a height h1 in the range from 1 μm to 50 μm, and a pitch P1 in the order of 5 μm; openings 43 have a rectangular shape; and openings 43 have a width w2 in the range from 1 μm to 45 μm, a height h2 in the range from 1 μm to 50 μm, and a pitch P2 in the range from 4 μm to 59 μm.

In practice, the association of the array of microlenses and of the first array, respectively, the second array, does not enable to fully block rays having an incidence greater than the first maximum incidence, respectively the second maximum incidence. It is then spoken of a blocking value, that is, the first maximum incidence value, respectively the second maximum incidence value, as being the half width at half maximum of the transmittance of array 27 and of array 31, respectively array 41, or the half width at half maximum of curve 59, respectively curve 61. In other words, the rays having an incidence equal to this value are blocked at 50%, the rays having an incidence greater than this value are mostly non-blocked and the rays having an incidence smaller than this value are mostly blocked by the association of the array of microlenses and of first array 31, respectively by second array 41.

With the previously-indicated dimensions, the half width at half maximum of curve 59 or half width at half maximum of the transmittance of the first array (HWHM) is equal to approximately 3.5° and the half width at half maximum of curve 61 or half width at half maximum of the transmittance of the second array is equal to approximately 20°.

First curve 59 comprises two second peaks, called secondary peaks, for incidences of approximately 25° and −25°. The transmittance, of rays having an incidence equal to approximately 25°, is approximately equal to 0.05. These secondary peaks correspond to the passage, through the array of microlenses 29 or first array 31, of rays having incidences in the range from approximately 20° to approximately 40°, captured by a photodetector 25 close to the photodetector 25 underlying microlens 29 or the opening 33 crossed by the ray.

Second curve 61 is characteristic of a bandpass filter letting through rays having incidences between 20° and −20°.

Mathematically, the values of curve 63 correspond to a multiplication of the value of curve 59 and of the value of curve 61 for a same given incidence. Third curve 63 has, as compared with curve 59, no secondary peaks. The transmittance of the rays beyond 20° then tends towards 0.

An advantage which appears is that the combination of two arrays of openings enables to completely block incident rays having an incidence greater than the second maximum incidence. The total blocking of incident rays having an incidence greater than the second maximum incidence enables to decrease, or even to suppress, the optical crosstalk corresponding to secondary peaks 63.

Various embodiments and variants have been described. Those skilled in the art will understand that certain features of these various embodiments and variants may be combined, and other variants will occur to those skilled in the art. The described embodiments are for example not limited to the examples of dimensions and of materials mentioned hereabove.

Finally, the practical implementation of the described embodiments and variations is within the abilities of those skilled in the art based on the functional indications given hereabove.

1. An angular filter for an image acquisition device comprising a stack, the angular filter comprising:
a first array of first openings delimited by first walls opaque to a visible and/or infrared radiation;
an array of microlenses; and
a second array of second openings delimited by second walls opaque to the visible and/or infrared radiation,
wherein the pitch of the second array is smaller than the pitch of the first array.

2. The angular filter according to claim 1, wherein the number of second openings is at least twice greater than the number of first openings.

3. The angular filter according to claim 1, wherein the array of microlenses is located between the first array and the second array.

4. The angular filter according to claim 1, wherein the second array is located between the array of microlenses and the first array.

5. The angular filter according to claim 1, wherein the first array is located between the array of microlenses and the second array.

6. The angular filter according to claim 1, wherein:
a structure comprising the array of microlenses and the first array is adapted to blocking incident rays having an incidence, with respect to the optical axes of the microlenses, greater than a first maximum incidence; and
the second array is adapted to blocking incident rays having an incidence, with respect to the optical axes of the microlenses, greater than a second maximum incidence, the second maximum incidence being greater than the first maximum incidence.

7. The angular filter according to claim 6, wherein the first maximum incidence which corresponds to the half width at half maximum of the transmittance is smaller than 10°, preferably smaller than 4°.

8. The angular filter according to claim 6, wherein the second maximum incidence which corresponds to the half width at half maximum of the transmittance is greater than 150 and smaller than 60°.

9. The angular filter according to claim 6, wherein the second maximum incidence is smaller than or equal to 30°.

10. The angular filter according to claim 1, wherein the first openings are filled with air, with a partial vacuum, or with a material at least partially transparent in the visible and infrared ranges.

11. The angular filter according to claim 1, wherein the second openings are filled with air, with a partial vacuum, or with a material at least partially transparent in the visible and infrared ranges.

12. The angular filter according to claim 1, wherein a single microlens is vertically in line with a first opening.

13. The angular filter according to claim 1, wherein each microlens is vertically in line with a single first opening.

14. The angular filter according to claim 1, wherein the optical axis of each microlens is aligned with the center of a first opening.

15. An acquisition device comprising an angular filter according to claim 1 and an image sensor.
